(19) United States
(12) Patent Application Publication
(10) Pub. No.: US 2026/0086801 A1
(43) Pub. Date: Mar. 26, 2026

(54) SYSTEMS AND METHODS FOR ENHANCED MATRIX OPERATIONS

(71) Applicant: Advanced Micro Devices, Inc., Santa Clara, CA (US)

(72) Inventors: Abhinav Vishnu, Austin, TX (US); Dhwani Satish Mehta, Austin, TX (US); Jeffrey Daily, Bellevue, WA (US)

(73) Assignee: Advanced Micro Devices, Inc., Santa Clara, CA (US)

(21) Appl. No.: 18/894,429

(22) Filed: Sep. 24, 2024

(51) Int. Cl. G06F 9/30; G06F 17/16

(52) U.S. Cl. CPC G06F 9/30025; G06F 9/30036; G06F 17/16

(57) ABSTRACT

A disclosed method may include converting a plurality of input tensors from a first floating-point format to a second floating-point format, the second floating-point format having a different exponent range in comparison to the first floating-point format. The method may further include generating, via a hardware accelerator, a result tensor by (1) executing a matrix operation using the plurality of input tensors in the second floating-point format, and (2) accumulating intermediate results of the matrix operation in a result register within the hardware compute unit using the first floating-point format. Various other methods, devices, and systems are also disclosed.

### BACKGROUND

Machine learning (ML) models traditionally utilize single precision 32-bit floating point representation (FP32) due to its wide acceptance and extensive model development over the past decade.

However, as the complexity and computational requirements of these models grow, the need for more efficient and effective computation methods becomes apparent. One such method is the use of TensorFloat32 (TF32), a precision format designed to accelerate artificial intelligence (AI) and machine learning workloads. However, TF32 is not available on all hardware accelerators. Furthermore, TF32 can offer only half the FLOPs rate of other formats, such as BF16 or FP16, limiting its efficiency for certain high-performance tasks. This leaves a gap in the market for a method that can provide the efficiency benefits of TF32 on hardware accelerators where TF32 is not available, as well as accelerate FP32 models.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for enhanced matrix operations.

FIG. 2 is a block diagram of an example implementation of a system for enhanced matrix operations.

FIG. 3 is a flow diagram of an example computer-implemented method 300 for enhanced matrix operations.

FIG. 4 includes a block diagram that illustrates a comparison between a conventional matrix operation and an emulated matrix operation in accordance with some embodiments.

FIG. 5 includes a code listing that includes pseudocode that, when implemented in a suitable programming language, may implement one or more of the methods described herein.

FIG. 6 includes a code listing that includes pseudocode that, when implemented in a suitable programming language, may implement one or more of the methods described herein.

FIG. 7 includes a code listing that includes pseudocode that, when implemented in a suitable programming language, may implement one or more of the methods described herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to systems and methods for enhanced matrix operations. As will be explained in greater detail below, embodiments of the instant disclosure may employ a unique approach of converting input tensors from a first floating-point format, such as FP32 or TF32, to a second floating-point format, such as BF16 or FP16. These converted tensors are then used to execute matrix operations, such as General Matrix Multiplications (GEMMs), in a hardware accelerator. Embodiments of the instant disclosure may significantly improve the functioning of a computer, specifically in the domain of executing matrix operations in ML tasks.

Embodiments of the instant disclosure may provide a substantial advantage over traditional technology by allowing for the efficient execution of matrix operations on hardware accelerators that do not have native support for the TF32 format. As described herein, a hardware accelerator may utilize a hardware compute unit that performs matrix operations using values in the second floating-point format (e.g., BF16, FP16, FP8, FP6, FP4, etc.) while accumulating intermediate results of the matrix operation in a result register that uses the first floating-point format (e.g., FP32). This unique approach improves the computational efficiency and performance of the hardware accelerator by leveraging the benefits of the second floating-point format's lower precision and higher speed.

Embodiments of the instant disclosure may further impact another technological field—machine learning. By increasing the computational efficiency of matrix operations, which are a core component of many machine learning tasks, embodiments of the instant disclosure may accelerate the training and execution of complex machine learning models.

Furthermore, this approach is designed to be user-transparent, meaning it requires no additional code changes at the application level, making it easily adoptable and non-disruptive to existing workflows. Thus, embodiments of the instant disclosure provide a practical and effective solution to limitations faced by traditional machine learning computations, thereby improving the functioning of the computer and the efficiency of machine learning tasks. In some examples, the approach described herein may be referred to as “TF32-emulation”.

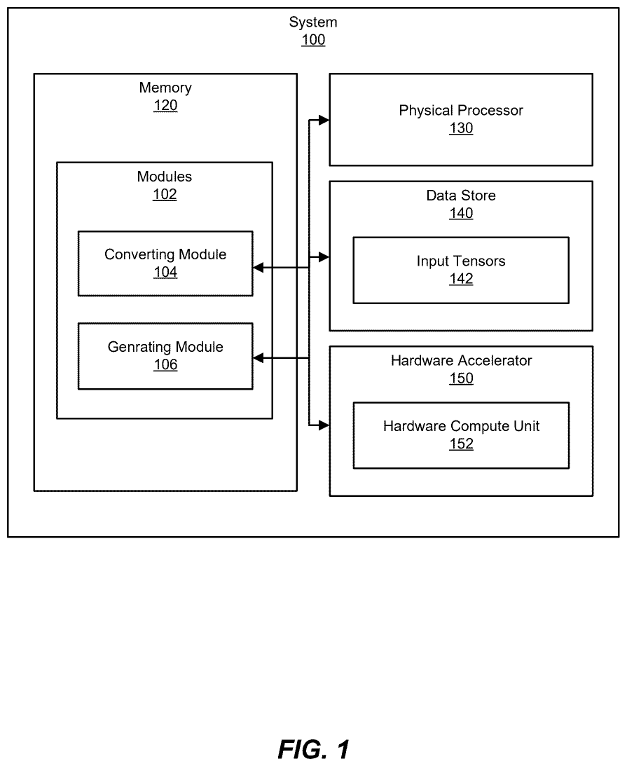

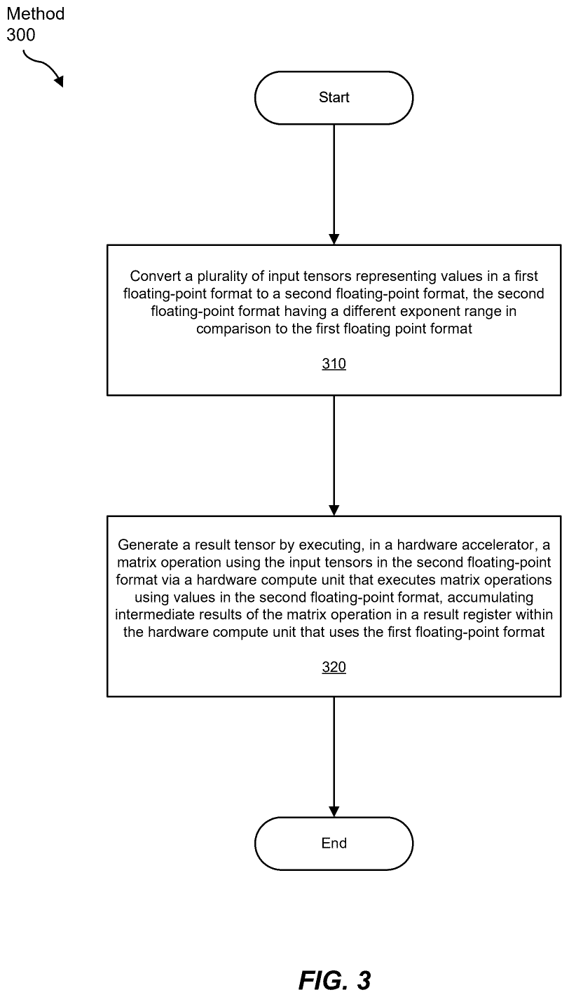

The following will provide, with reference to FIGS. 1-2 and 4-7, detailed descriptions of systems for enhanced matrix operations. Detailed descriptions of corresponding computer-implemented methods will also be provided in connection with FIG. 3.

FIG. 1 is a block diagram of an example system 100 for enhanced matrix operations. As illustrated in this figure, example system 100 may include one or more modules 102 for performing one or more tasks. As will be explained in greater detail below, modules 102 may include a converting module 104 that converts a plurality of input tensors representing values in a first floating-point format (e.g., FP32) to a second floating-point format (e.g., BF16, FP16, FP8, FP6, FP4, etc.). Example system 100 may also include a generating module 106 that generates a result tensor by executing a matrix operation (e.g., a GEMM) using the input tensors in the second floating-point format. This operation is performed by a hardware compute unit included in the hardware accelerator, which is designed to execute matrix operations using values in the second floating-point format. As part of the matrix operation, the generating module may accumulate intermediate results of the matrix operation in a result register within the hardware compute unit using the first floating-point format (e.g., FP32).

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, processor caches, Random Access Memory (RAM), Read Only Memory (ROM), flash memory, Hard Disk Drives (HDDs), Solid-State Drives (SSDs), optical disk drives, storage caches, variations or combinations of one or more of the same, or any other suitable storage memory.

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate enhanced matrix operations. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also illustrated in FIG. 1, example system 100 may also include one or more stores of data, such as data store 140. Data store 140 may represent portions of a single data store or computing device or a plurality of data stores or computing devices. In some embodiments, data store 140 may be a logical container for data and may be implemented in various forms (e.g., a database, a file, file system, a data structure, etc.). Examples of data store 140 may include, without limitation, one or more files, file systems, data stores, databases, and/or database management systems such as an operational data store (ODS), a relational database, a NoSQL database, a NewSQL database, and/or any other suitable organized collection of data.

As further shown in FIG. 1, data store 140 may include input tensors 142. Input tensors 142 may represent single-and/or multi-dimensional arrays of data for matrix operations. As will be described in additional detail below, converting module 104 may initially receive these tensors in a first floating-point format and may then convert them to a second format for optimized processing.

Example system 100 also includes a hardware accelerator 150. Hardware accelerator 150 may be configured to or capable of performing certain types of computations (e.g., tensor operations) more efficiently than general-purpose CPUs. Under the direction of the generating module 106, it may execute a matrix operation using the input tensors in the second floating-point format. The hardware compute unit 152, located within the hardware accelerator 150, executes matrix operations using values in the second floating-point format. It may also be configured to accumulate intermediate results of the matrix operation in a result register using the first floating-point format. The specialized design of the hardware compute unit 152 may allow for efficient processing of these operations, leading to improved performance in the overall system. In some examples, a device that physically and/or logically hosts a hardware accelerator (e.g., hardware accelerator 150) and/or provides instructions and/or data to the hardware accelerator may be referred to as a host device.

In some instances, hardware accelerator 150 can take the form of a graphics processing unit (GPU) equipped with a variable number of compute units. The specific number of compute units may be dependent on a design of the graphics processing unit. For instance, an AMD MI250X Instinct accelerator may have 110 compute units, while an AMD MI300 Instinct accelerator might feature 304 compute units, among other possible configurations.

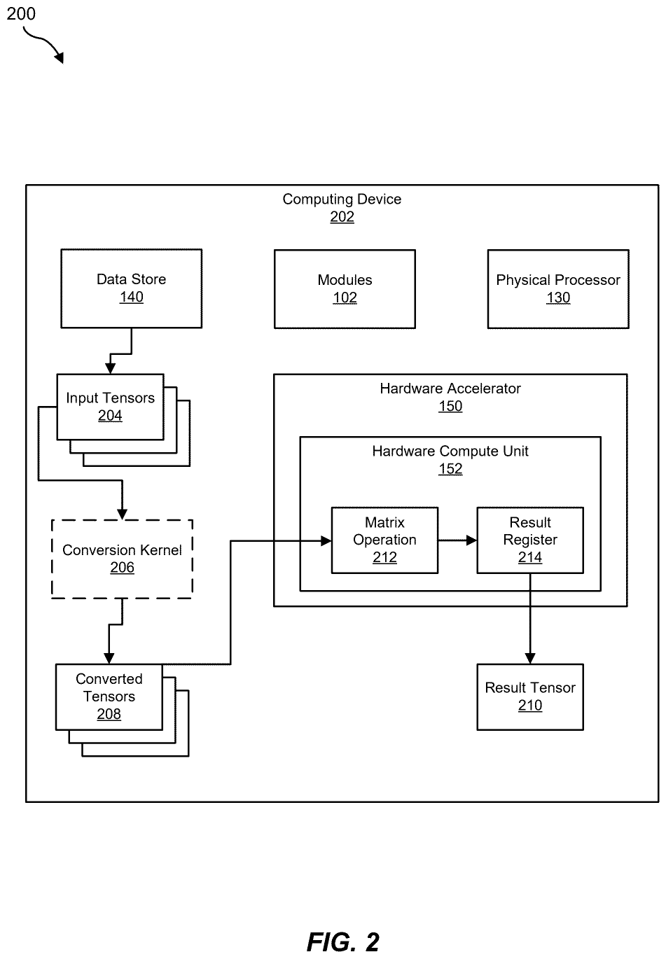

Example system 100 in FIG. 1 may be implemented in a variety of ways. For example, all or a portion of example system 100 may represent portions of an example system 200 (“system 200”) in FIG. 2. As shown in FIG. 2, system 200 may include a computing device 202. In at least one example, computing device 202 may be programmed with one or more of modules 102.

In at least one embodiment, one or more modules 102 from FIG. 1 may, when executed by computing device 202, enable computing device 202 to perform one or more operations to enable enhanced matrix operations. For example, as will be described in greater detail below, converting module 104 may cause computing device 202 to convert a plurality of input tensors (e.g., input tensors 204) representing values in a first floating-point format (e.g., FP32) to a second floating-point format (e.g., BF16, FP16, FP8, FP6, FP4, etc.). In some examples, converting module 104 may employ a conversion kernel (e.g., conversion kernel 206, an optional component denoted by dashed lines) to convert the input tensors (e.g., input tensors 204) to the converted tensors (e.g., converted tensors 208).

In some examples, the second floating-point format may have a different exponent range in comparison to the first floating point format. The floating-point formats TF32, FP32, BF16, FP16, and FP8 exhibit both differences and similarities in their exponent ranges. TF32 and FP32 share the same exponent range, offering 8 bits for the exponent, thereby accommodating a wide range of values. BF16, while also utilizing 8 bits for the exponent, pairs this with a reduced precision for the significand. FP16, in contrast, employs a 5-bit exponent, resulting in a more limited range compared to TF32, FP32, and BF16. The FP8 format varies, as it comes in two versions: E4M3 and E5M2. E4M3 provides a 4-bit exponent, whereas E5M2 offers a 5-bit exponent, the latter of which aligns more closely with FP16 in range capabilities. Despite the variations in precision and specific exponent bits, the core similarity among these formats lies in their use of exponential representation to manage a broad spectrum of numerical values, with each format striking a balance between range and precision suitable to different computational needs.

Additionally, as will be described in greater detail below, generating module 106 may cause computing device 202 to generate a result tensor (e.g., result tensor 210) by executing, in a hardware accelerator (e.g., hardware accelerator 150), via a hardware compute unit (e.g., hardware compute unit 152), included in the hardware accelerator, that executes matrix operations using values in the second floating-point format, a matrix operation (e.g., matrix operation 212) using the input tensors in the second floating-point format, accumulating intermediate results of the matrix operation in a result register (e.g., result register 214) within the hardware compute unit using the first floating-point format.

Computing device 202 generally represents any type or form of computing device capable of reading and/or executing computer-executable instructions. Examples of computing device 202 include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

In at least one example, computing device 202 may be a computing device programmed with one or more of modules 102. All or a portion of the functionality of modules 102 may be performed by computing device 202 and/or any other suitable computing system. As will be described in greater detail below, one or more of modules 102 from FIG. 1 may, when executed by at least one processor of computing device 202, may enable computing device 202 to enhanced matrix operations.

Many other devices or subsystems may be connected to system 100 in FIG. 1 and/or system 200 in FIG. 2. Conversely, all of the components and devices illustrated in FIGS. 1 and 2 need not be present to practice the embodiments described and/or illustrated herein. The devices and subsystems referenced above may also be interconnected in different ways from those shown in FIG. 2. Systems 100 and 200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 3 is a flow diagram of an example computer-implemented method 300 for enhanced matrix operations. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may convert a plurality of input tensors representing values in a first floating-point format to a second floating-point format, the second floating-point format having a different exponent range in comparison to the first floating point format. For example, converting module 104 may, as part of computing device 202, convert input tensors 204 to converted tensors 208.

In some examples, as mentioned above, input tensors 204 may represent values in a first floating-point format, such as FP32. Likewise, converted tensors 208 may represent the same values as represented by input tensors 204, but in a second, different floating-point format.

A first floating-point format may distinguish itself from a second floating-point format through several features. These features may include the number of bits allocated to the exponent and significand, which may directly influence the format's range and precision. Additionally, the presence of subnormal numbers, which allow for the representation of values closer to zero, can vary between formats. The encoding scheme and any special values, such as infinities and NaNs (Not a Number), also contribute to differences. Another distinguishing feature is the rounding behavior, which can affect computational accuracy and consistency. Some formats may also include specific optimizations for certain types of operations, such as tensor computations in machine learning. Moreover, the hardware and software support for each format can vary, influencing their efficiency and applicability in different computational environments.

For instance, FP32 has 23 significand bits and 8 exponent bits, offering high precision and a broad range. In contrast, BF16 has 7 significand bits and 8 exponent bits, trading off some precision for simpler hardware implementation. FP16, with 10 significand bits and 5 exponent bits, provides less range and precision than FP32 but is more efficient in terms of storage and computation. The FP8 format comes in two variants: E4M3 with 3 significand bits and 4 exponent bits, and E5M2 with 2 significand bits and 5 exponent bits, each balancing range and precision differently. These differences in representable ranges of significands and exponents are critical in determining the suitability of a format for specific computational tasks.

In some examples, converting module 104 may convert input tensors 204 to converted tensors 208 via the use of a conversion kernel 206. A conversion kernel may be or include a specialized software routine or function used in parallel computing environments, particularly in GPUs and other high-performance computing contexts, to efficiently convert data between different formats or representations. These kernels may handle the conversion of data types, such as from one floating-point format to another (e.g., from FP32 to FP16), or from integers to floating-point numbers and vice versa. Conversion kernels leverage the parallel processing capabilities of GPUs to perform these transformations at high speed and with low latency, ensuring minimal performance impact on the overall computation. They may be helpful in scenarios where data needs to be transformed to optimize memory usage, improve computational efficiency, or meet specific precision requirements for different stages of a computation or for interoperability between different software and hardware components.

One example may include a FP32 to FP16 conversion kernel, which transforms 32-bit floating-point numbers to 16-bit floating-point numbers, reducing memory usage and enhancing computational efficiency without significantly compromising precision. Conversely, a FP16 to FP32 conversion kernel may convert 16-bit floating-point numbers back to 32-bit, providing higher precision when needed. A BF16 to FP32 conversion kernel may serve a similar purpose, translating 16-bit Brain Floating Point numbers to 32-bit floating-point for increased precision in specific operations. Another type, the integer to floating-point conversion kernel, may change integer values to floating-point representations, useful for arithmetic operations requiring floating-point precision. A floating-point to integer conversion kernel may perform the opposite transformation, often employed when computation results need to be stored or processed as integers.

Furthermore, quantization and dequantization kernels may convert floating-point numbers to quantized integer representations and back, optimizing storage and computation, especially in neural network inference. Additionally, data format conversion kernels handle transformations between different data formats, such as converting neural network inputs from NHWC (Number of images, Height, Width, Channels) to NCHW (Number of images, Channels, Height, Width). These kernels may leverage the parallel processing capabilities of GPUs or other specialized hardware to perform conversions efficiently, optimizing performance and interoperability in various computational tasks.

Returning to FIG. 3, at step 320, one or more of the systems described herein may generate a result tensor. For example, generating module 106 may, as part of computing device 202, generate result tensor 210. The generating module 106 manages the execution of matrix operations within a hardware accelerator, such as hardware accelerator 150, using the converted tensors 208. As described above, converting module 104 converts these tensors from a first floating-point format to a second floating-point format.

Within the hardware compute unit 152, which is configured, designed, and/or purposed to perform matrix operations such as GEMMs. Generating module 106 may load the converted tensors into designated operand registers. These registers may be specifically configured to handle computations using the second floating-point format. Generating module 106 may manage a flow of converted tensors into the operand registers, ensuring that the hardware compute unit is configured and/or prepared for efficient operation.

As the matrix operation progresses, generating module 106 causes accumulation of intermediate results within result register 214.

During a GEMM operation, intermediary accumulations play a crucial role in computing the final result. A GEMM operation involves multiplying two matrices, A and B, and typically adding the result to a third matrix, C, following the equation C=αAB+βC, where α and β are scalar coefficients.

The intermediary accumulations occur as follows. Each element of the resultant matrix C is computed as the sum of the products of corresponding elements from a row of matrix A and a column of matrix B. For each element Cᵢⱼ in the resulting matrix C, the operation involves summing up the products Aᵢₖ×Bₖⱼ for all k, where i is the row index and j is the column index.

During the computation of each element Cᵢⱼ, the products Aᵢₖ×Bₖⱼ are accumulated into a partial sum. This intermediary accumulation continues for all values of k, gradually building up the value of Cᵢⱼ. These partial sums are stored in temporary variables and updated iteratively as each product is computed.

After the accumulation of all partial sums for a particular element Cᵢⱼ, the result is scaled by the scalar coefficient α. If matrix C was initially non-zero, the original value of Cᵢⱼ is scaled by β and added to the accumulated sum. This step involves additional intermediary accumulation as the scaled value of Cᵢⱼ is combined with the accumulated product sum.

Once the intermediary accumulations are complete, the final value of each element Cᵢⱼ is stored in the resultant matrix C. This process is repeated for all elements in the matrix, resulting in the complete computation of the GEMM operation.

Intermediary accumulations are critical for ensuring numerical stability and accuracy during the matrix multiplication process. Efficient handling of these accumulations, especially in parallel and distributed computing environments, is essential for optimizing the performance of GEMM operations.

Result register 214 may operate using the first floating-point format, which may provide higher precision and range. Accumulation in this format may serve to prevent any potential precision loss during the computation's intermediate stages. Upon completion of the matrix operation, the aggregated intermediate results yield result tensor 210 in the original first floating-point format. The preservation of this format enables integration with subsequent computational stages or output requirements.

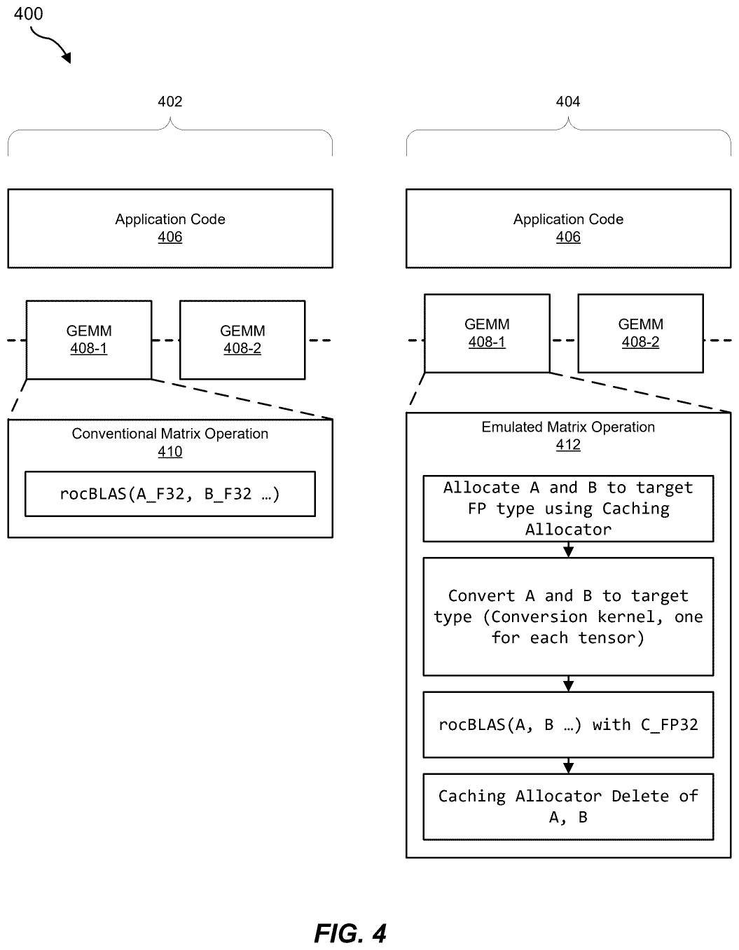

FIG. 4 includes a block diagram 400 that illustrates a comparison between a conventional matrix operation flow 402 and an emulated matrix operation flow 404. As shown, both conventional matrix operation flow 402 and emulated matrix operation flow 404 include application code 406 and a set of GEMM operations 408 (e.g., GEMM 408-1 and GEMM 408-2). This may indicate that conventional matrix operation 410 and emulated matrix operation 412 may be user- and/or application-transparent. For example, the executing of conventional matrix operation flow 402 and emulated matrix operation flow 404 within a machine learning software development framework like the popular PyTorch software development framework may involve substantially identical function calls, and may therefore be transparent on a user or application level. As shown in conventional matrix operation 410, the matrix operation (in this example, a GEMM), may be executed via a call to a rocBLAS( ) function, with a first input tensor (A_F32) and a second input tensor (B_F32), both in a 32-bit floating-point format.

In the conventional matrix operation flow 402, the conventional matrix operation 410 is executed via a call to a rocBLAS( ) function. This function processes a first input tensor A_F32 and a second input tensor B_F32, both of which are in a 32-bit floating-point format. The conventional approach directly uses these 32-bit tensors for the GEMM operations.

On the other hand, the emulated matrix operation 412 involves additional steps to accommodate different floating-point formats. First, it allocates memory for tensors A and B using a caching allocator, targeting a different floating-point format. Subsequently, it converts tensors A and B to the target floating-point format using a conversion kernel, with a separate conversion kernel applied to each tensor. After the conversion, the rocBLAS( ) function is called with the converted tensors A and B, with a target or result register C_FP32, in the 32-bit floating-point format. Finally, the caching allocator deletes the allocated memory for tensors A and B.

This emulated approach allows for flexibility in using different floating-point formats, potentially optimizing performance and resource usage for specific computational tasks. The comparison highlights the additional steps involved in the emulated matrix operation, aimed at managing the conversion and memory allocation efficiently.

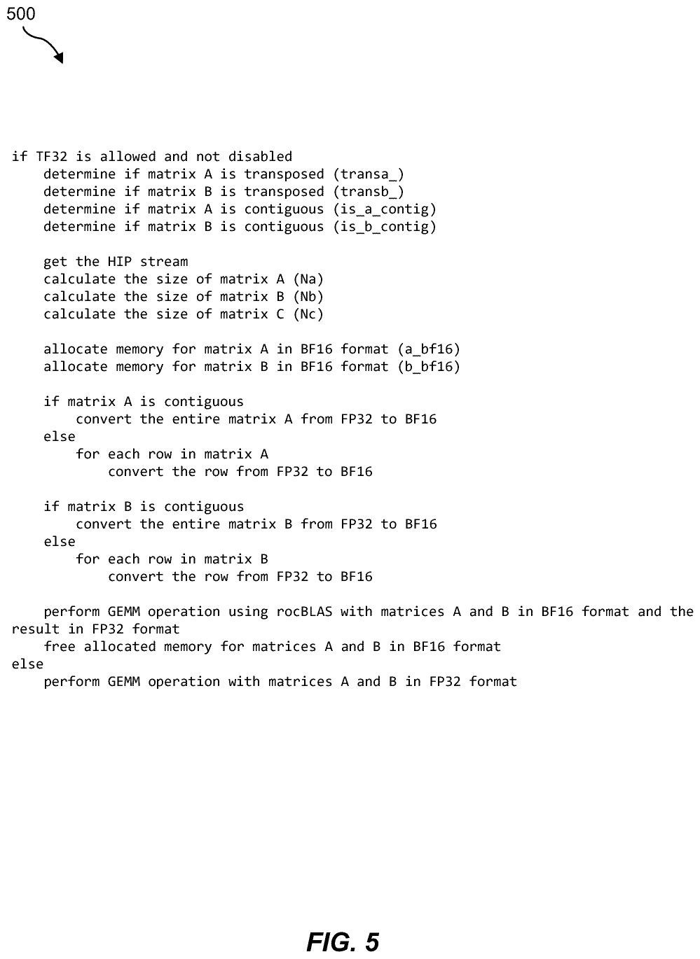

FIG. 5 includes a code listing 500 that includes pseudocode that, when implemented in a suitable programming language, may implement one or more of the methods described herein. The pseudocode begins by checking if the TF32 format is allowed and not disabled, indicating that the proceeding operations will be performed using the TF32-emulation method as described in the present disclosure. It then determines whether matrices A and B are transposed (represented by variables transa_ and transb_) and whether they are contiguous (represented by variables is_a_contig and is_b_contig).

The code then retrieves the current HIP (Heterogeneous-compute Interface for Portability) stream, which is used for executing commands on the GPU. It calculates the sizes of matrices A, B, and C (represented by variables Na, Nb, and Nc) and allocates memory for matrices A and B in the BF16 format (represented by variables a_bf16 and b_bf16).

The code then converts matrices A and B from the FP32 format to the BF16 format. If a matrix is contiguous, the entire matrix is converted at once. If a matrix is not contiguous, each row of the matrix is converted individually.

After the conversion, a GEMM operation is performed using the rocBLAS library with matrices A and B in the BF16 format and the result in the FP32 format. The allocated memory for matrices A and B in the BF16 format is then freed.

If TF32 is not allowed or disabled, the GEMM operation is performed with matrices A and B in the FP32 format. This alternative path ensures that the GEMM operation can still be performed even if TF32-emulation is not used.

Overall, code listing 500 outlines a method for executing a GEMM operation using either the TF32-emulation method or the standard FP32 format, depending on the availability of and the allowance of the TF32 format.

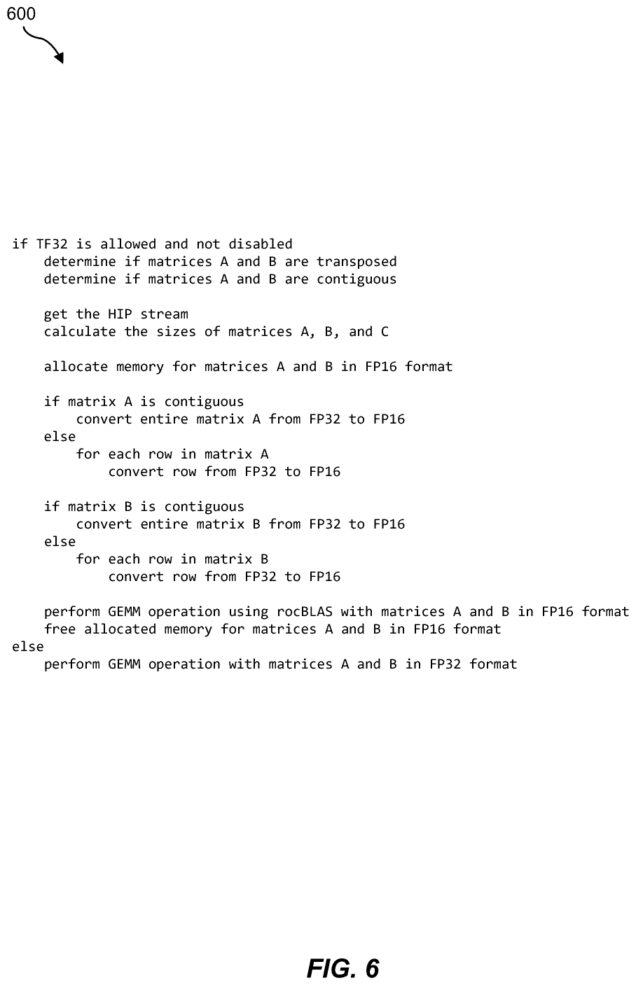

FIG. 6 includes a code listing 600 that includes pseudocode that, when implemented in a suitable programming language, may implement one or more of the methods described herein. The pseudocode starts by checking if the TF32 format is allowed and not disabled. If so, the ensuing operations will be executed using an emulation method that employs FP16. The pseudocode then determines if matrices A and B are transposed and whether they are contiguous.

The HIP stream is then retrieved. This stream is used for executing commands on the GPU. The sizes of matrices A, B, and C are then calculated. Memory for matrices A and B in FP16 format is then allocated. The code then converts matrices A and B from the FP32 format to the FP16 format. If a matrix is contiguous, the entire matrix is converted in one step. However, if the matrix is not contiguous, each row of the matrix is converted individually.

Following the conversion, a GEMM operation is performed using the rocBLAS library with matrices A and B in the FP16 format. The allocated memory for matrices A and B in FP16 format is then freed.

If TF32 is not allowed or disabled, the GEMM operation is performed with matrices A and B in the FP32 format. This alternative path ensures that the GEMM operation can still be performed even if the emulation method is not used.

Overall, this pseudocode details a method for executing a GEMM operation using either an emulation method that employs FP16 instead of the standard FP32 format, depending on the availability of and the allowance of the TF32 format.

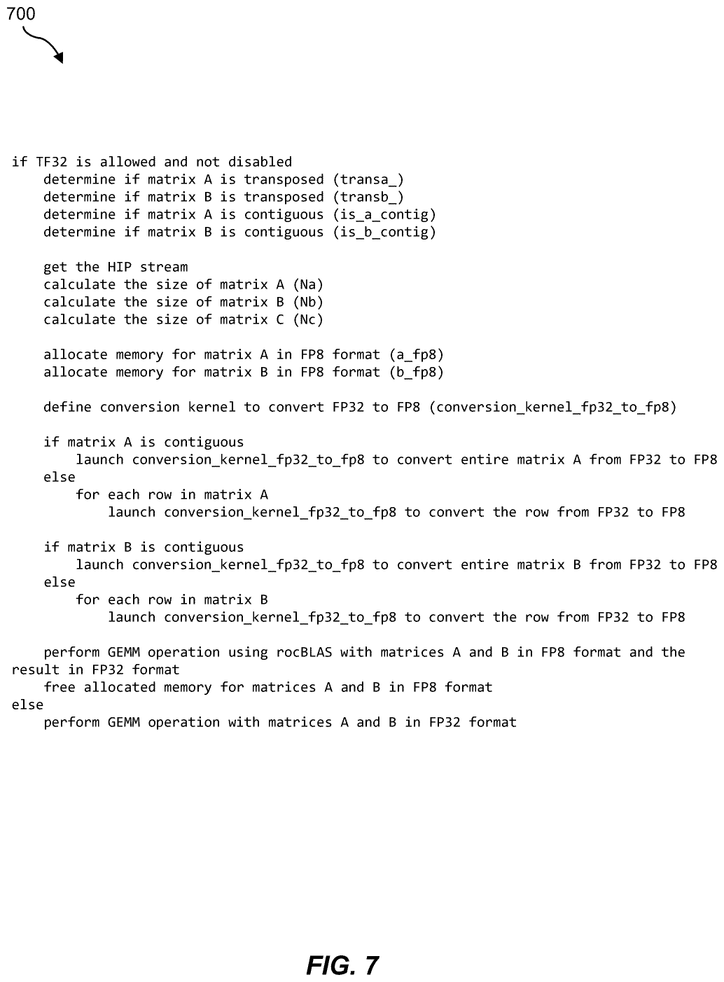

FIG. 7 includes a code listing 700 that includes pseudocode that, when implemented in a suitable programming language, may implement one or more of the methods described herein. The pseudocode is a procedural set of instructions intended for execution within a computing environment. This code is designed to facilitate a GEMM operation.

The pseudocode begins with a conditional block that checks for the allowance and enablement of TF32. If these conditions are met, the code determines the orientation (transposed or not) and memory layout (contiguous or not) of input matrices A and B through variables transa_, transb_, is_a_contig, and is_b_contig.

The HIP stream is then acquired, which is necessary for command execution on the GPU. The sizes of the input matrices A, B, and the result matrix C are computed and stored in variables Na, Nb, and Nc, respectively.

Memory allocation for matrices A and B follows, with a specific allocation for the FP8 (8-bit floating-point) representation, indicated by variables a_fp8 and b_fp8. A conversion kernel, defined as conversion_kernel_fp32_to_fp8, is declared to facilitate the transformation of data from a 32-bit floating-point format (FP32) to an 8-bit format (FP8). The code branches depending on whether the input matrices are contiguous. If an input matrix is contiguous, the entire matrix is converted from FP32 to FP8 using the conversion kernel. If it is not, the conversion is performed row by row.

After both matrices A and B have been converted to FP8 format, a GEMM operation is executed utilizing the rocBLAS library. This operation processes the matrices in FP8 format and accumulates the result in FP32 format. Post-calculation, the memory allocated for the FP8 representations of matrices A and B is deallocated.

If TF32 is not allowed or is disabled, the GEMM operation defaults to performing the GEMM operation with matrices A and B in the original FP32 format. This ensures compatibility and functionality across various hardware configurations and software environments.

Overall, the pseudocode reflects a computational method that leverages the lower precision FP8 format to potentially enhance the performance of GEMM operations while using a higher precision format for the final result. This technique may be particularly beneficial in applications where memory bandwidth or computational throughput is a limiting factor, such as in certain machine learning workloads.

As discussed throughout the instant disclosure, the disclosed systems and methods may provide one or more advantages over traditional options for performing vector operations. The present disclosure introduces a groundbreaking approach to accelerating ML models by emulating the TensorFloat32 precision format on GPUs that do not natively support it, such as the AMD Instinct MI250X. This emulation technique enables these GPUs to perform vector operations like GEMMs—a critical computation in ML workloads—more efficiently by converting the input data from single-precision 32-bit floating-point format (FP32) to a different, possibly more efficient format (e.g., BF16, FP16, FP8, FP6, FP4, etc.) before computation, and then accumulating the results back in FP32.

In some implementations, code may involve converting the input tensors to tensors having a target floating-point representation (e.g., BF16, FP16, FP8, FP6, FP4, etc.) and making a rocBLAS call with the target tensors. In some instances, such as in the popular PyTorch machine learning library, the usage of TF32 for GEMMs may be controlled by a torch.backends.cudnn.allow_tf32 flag. When flag is set to true it allows the usage of TF32 precision for GEMMs and when the flag is false allows the usage of FP32 precision for all computations. To avoid divergence with the upstream PyTorch, some embodiments may enable the same torch.backends.cudnn.allow_tf32 flag in PyTorch which, when set to true takes the TF32-emulation path (i.e. using a target precision for non-batched GEMMs (MEDIUM mode)). When the flag is set to true, float32_matmul_precision is set to MEDIUM mode.

By adapting the existing infrastructure within the PyTorch machine learning framework, the TF32-Emulation approach of the instant disclosure requires no modifications to the application code, providing a user-transparent experience. Notably, this emulation method has demonstrated a significant performance improvement. Indeed, in some examples, one or more of the systems or methods described herein may cause or observe convergence of at least one performance metric for a machine learning model implemented using a hardware accelerator with native support for execution of matrix operations using the first floating-point format versus TF32-Emulation approach described herein.

Embodiments of the present disclosure may uniquely benefit GPUs that lack native TF32 support, potentially eliminating the need for TF32 in future GPU generations. It also specifically enhances the performance of linear layers in PyTorch, which are fundamental components in large language models (LLMs). The emulation method is not only restricted to BF16 but can also be applied using other reduced precision formats such as FP8 and FP16.

In summary, the TF32-Emulation approach of the instant disclosure provides a strategic advantage by increasing the computational speed and efficiency of ML models on GPUs without native TF32 support, while maintaining accuracy and requiring no additional changes to the user's application code. This innovation paves the way for more resource-efficient ML model training and inference, especially on AMD and other hardware platforms without native TF32 support.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive FP32 format data to be transformed, transform the FP32 format data to another target floating point format, output a result of the transformation to execute a vector function, use the result of the transformation to perform an additional vector function, and store the result of the transformation to present an output of the vector function. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems. Hence, in some examples, a non-transitory computer readable medium may have encoded thereon executable instructions that, when executed by at least one processor, cause the at least one processor to carry out one or more of the operations described herein.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
converting a plurality of input tensors from a first floating-point format to a second floating-point format, the second floating-point format having a different exponent range in comparison to the first floating-point format; and
generating, via a hardware accelerator, a result tensor by:
executing a matrix operation using the plurality of input tensors in the second floating-point format; and
accumulating intermediate results of the matrix operation in a result register using the first floating-point format.

2. The method of claim 1, further comprising executing the matrix operation using the plurality of input tensors in the second floating-point format via a hardware compute unit included in the hardware accelerator, the hardware compute unit configured to execute matrix operations using the second floating-point format.

3. The method of claim 1, wherein the hardware accelerator lacks hardware support for that executing matrix operations using values in the first floating-point format.

4. The method of claim 1, wherein the matrix operation comprises a General Matrix Multiplication (GEMM) operation, and the converted plurality of input tensors are used as inputs to the GEMM operation.

5. The method of claim 1, wherein the first floating-point format comprises a 32-bit floating point (FP32) representation.

6. The method of claim 1, wherein the second floating-point format comprises at least one of:
a 4-bit floating-point representation (FP4);
a 6-bit floating-point representation (FP6);
an 8-bit floating-point representation (FP8);
a 16-bit floating-point representation (FP16); or
a 16-bit brain floating-point representation (BF16).

7. The method of claim 1, wherein the first floating-point format has a higher numerical precision than the second floating-point format.

8. The method of claim 1, further comprising converting the plurality of input tensors representing values in the first floating-point format to the second floating-point format via a conversion kernel included in a machine learning software development framework.

9. The method of claim 1, wherein the converting of the input tensors and the executing of the matrix operation are transparent to a user application utilizing a machine learning software development framework.

10. The method of claim 1, wherein the executing of the matrix operation using the second floating-point format improves performance of the hardware accelerator compared to an execution of the matrix operation using the first floating-point format.

11. The method of claim 1, further comprising observing convergence of at least one performance metric for a machine learning model implemented using an additional hardware accelerator with native support for execution of matrix operations using the first floating-point format versus the machine learning model implemented via:
converting the plurality of input tensors from the first floating-point format to the second floating-point format; and
generating, via the hardware accelerator, a result tensor by:
executing a matrix operation using the plurality of input tensors in the second floating-point format; and
accumulating intermediate results of the matrix operation in a result register using the first floating-point format.

12. A hardware accelerator comprising:
a hardware compute unit comprising:
a result register configured to store an accumulated value in a first floating-point format;
a matrix multiplication unit configured to execute matrix multiplication operations in a second floating-point format, the second floating-point format having a different exponent range in comparison to the first floating-point format;
wherein the hardware accelerator is configured to:
receive a plurality of input tensors representing values converted from the first floating-point format to the second floating-point format;
generate, via the hardware compute unit, a result tensor by:
executing, via the matrix multiplication unit, a matrix operation using the plurality of input tensors in the second floating-point format; and
accumulating intermediate results of the matrix operation in the result register within the hardware compute unit using the first floating-point format.

13. The hardware accelerator of claim 12, wherein the matrix operation comprises a General Matrix Multiplication (GEMM) operation, and the converted input tensors are used as inputs to the GEMM operation.

14. The hardware accelerator of claim 12, wherein the first floating-point format comprises a 32-bit floating point (FP32) representation.

15. The hardware accelerator of claim 12, wherein the second floating-point format comprises at least one of:
a 4-bit floating-point representation (FP4);
a 6-bit floating-point representation (FP6);
an 8-bit floating-point representation (FP8);
a 16-bit floating-point representation (FP16); or
a 16-bit brain floating-point representation (BF16).

16. The hardware accelerator of claim 12, wherein the first floating-point format has a higher numerical precision than the second floating-point format.

17. The hardware accelerator of claim 12, wherein the hardware accelerator comprises a graphics processing unit.

18. The hardware accelerator of claim 17, wherein the graphics processing unit comprises at least one of:
at least 110 compute units; or
at least 304 compute units.

19. A system comprising:
a host device configured to convert a plurality of input tensors from a first floating-point format to a second floating-point format, the second floating-point format having a different exponent range in comparison to the first floating-point format;
a hardware accelerator configured to generate a result tensor by:
executing a matrix operation using the plurality of input tensors in the second floating-point format; and
accumulating intermediate results of the matrix operation in a result register using the first floating-point format.

20. The system of claim 19, further comprising a hardware compute unit comprising:
the result register, the result register configured to store the intermediate results of the matrix operation in the first floating-point format; and
a matrix multiplication unit configured to execute the matrix operation using the plurality of result tensors in the second floating-point format.
